(19) United States
(12) Patent Application Publication
(10) Pub. No.: US 2026/0026476 A1
(43) Pub. Date: Jan. 29, 2026

(54) SIPHON FISH TANK CLEANING DEVICE

(71) Applicant: Shenzhen Aiku Pet Technology Co., Ltd., Shenzhen (CN)

(72) Inventor: Hua DENG, Shenzhen (CN)

(21) Appl. No.: 18/784,010

(22) Filed: Jul. 25, 2024

(51) Int. Cl. A01K 63/04

(52) U.S. Cl. CPC A01K 63/045

(57) ABSTRACT

The present application provides a siphon fish tank cleaning device comprising a support assembly and a pipeline assembly. A feeding portion is connected to a water inlet of a water pipe and floats on a water surface, sucks oil dirt and conveys the oil dirt to the water pipe. A discharging portion is connected to a water outlet of the water pipe and located outside a fish tank, receives the oil dirt and discharges the oil dirt outside the fish tank. The discharging portion and the feeding portion are located inside and outside the fish tank respectively. A position of the discharging portion is lower than that of the feeding portion, and a siphon structure is formed based on the feeding portion, the water pipe and the discharging portion, so that the oil dirt is sucked by a siphon force, to facilitate autonomous discharge of the oil dirt.

### TECHNICAL FIELD

The present invention relates to the technical field of fish tank cleaning devices, and in particular, to a siphon fish tank cleaning device.

### BACKGROUND ART

With the development of science and technology, fish tanks are used in people's life, and fish tank cleaning devices are used to clean the fish tanks. In the prior art, the existing fish tank cleaning device pumps water in an aquarium into a filter tank by a water pump, the water is filtered by a filter material in the filter tank, the filter material leaves harmful substances or impurities in the water in the filter tank, and the filtered water returns to the aquarium, so that the fish tank can be cleaned by the water pump. However, the water pump needs to be electrified before the water pump can be used for cleaning, which affects safety of the existing fish tank cleaning device.

### SUMMARY OF THE INVENTION

An objective of the present invention is to provide a siphon fish tank cleaning device, to solve the above-mentioned problem.

To achieve the foregoing objective, the present invention provides the following technical solution.

A siphon fish tank cleaning device is applied to a fish tank dirt discharge scenario, and the siphon fish tank cleaning device comprises:
a support assembly comprising a support and a sucker, wherein the support is located in a fish tank; and a fixed end of the sucker is connected to the support, and a suction end of the sucker sucks a side wall of the fish tank in a horizontal direction; and
a pipeline assembly mounted on the support, wherein the pipeline assembly comprises a water pipe, a feeding portion, and a discharging portion, wherein
the water pipe is provided in a snake shape, and is partially located in the fish tank;
the feeding portion is connected to a water inlet of the water pipe and floats on a water surface, and the feeding portion sucks oil dirt collected via the water surface and conveys the oil dirt to the water pipe; and
the discharging portion is connected to a water outlet of the water pipe and is located outside the fish tank, the discharging portion receives the oil dirt conveyed through the water pipe and discharges the oil dirt outside the fish tank, and the discharging portion and the feeding portion are located inside and outside the fish tank respectively, at the same time, a height position of the discharging portion is lower than that of the feeding portion, and in this case, a siphon structure is formed based on the feeding portion, the water pipe, and the discharging portion, so that the oil dirt is sucked by a siphon force.

Optionally, the feeding portion comprises a first body and a first connecting end;
the first connecting end is located on a lower side of the first body and is inserted into the water outlet of the water pipe; and an outer side wall of the first connecting end is hermetically connected to an inner side wall of the water inlet of the water pipe, or a gap for water to pass through is provided between the outer side wall of the first connecting end and the inner side wall of the water inlet of the water pipe;
the first body is made of a floatable material and floats on the water surface; and the first body is in communication with the first connecting end and is in communication with the water inlet of the water pipe by the first connecting end; and
the first body is provided with a plurality of first water ports, the plurality of first water ports are uniformly provided along an outer side wall of the first body and converge at a central hole of the first body, and the plurality of first water ports allow the oil dirt to enter in different directions respectively.

Optionally, the plurality of first water ports are all staged grooves; each first water port is located at the water surface, and a bottom of the first water port is lower than the water surface; and
the first body is further provided with spiral flow channels, the spiral flow channels are located between the first water ports and the central hole, and the first water ports, the spiral flow channels and the central hole are in communication with each other and are configured to convey water and oil dirt.

Optionally, a plurality of spiral flow channels are provided, and a number of the spiral flow channels is consistent with that of the first water ports; and
the plurality of spiral flow channels are provided at intervals in an annular direction of the first body and converge at the same central hole; and each spiral flow channel spirally extends from top to bottom.

Optionally, an aperture of a water inlet end of the spiral flow channel is greater than that of a water outlet end of the spiral flow channel; and
the aperture of the spiral flow channel gradually decreases in a spiral direction of the spiral flow channel.

Optionally, the feeding portion is rotatably connected to the water pipe and rotates along an axis of the feeding portion; and
when water enters the first water port, the water impacts the spiral flow channel and applies rotating power to the feeding portion, the feeding portion rotates relative to the water pipe under the action of the rotating power, and at the same time, a water inlet situation of the water pipe is reflected based on a rotating situation of the feeding portion.

Optionally, the water pipe comprises a main pipe portion, a bent portion, and a vertical portion;
an upper end of the bent portion is used as the water inlet, and the bent portion is located in the fish tank and is immersed in water;
the main pipe portion is arranged in a horizontal direction and is in communication with the bent portion and the vertical portion; the vertical portion is located on a side of the bent portion, an accommodating groove is formed between the vertical portion and the bent portion, and the accommodating groove is configured to a side plate of the fish tank to pass through; and
the vertical portion extends in a vertical direction, the discharging portion is connected to the vertical pipe, a first switch is connected to the discharging portion, and the first switch is configured to open or close the water outlet of the water pipe.

Optionally, a plurality of vertical portions are provided, and the plurality of vertical portions are arranged in a horizontal direction and are in communication with the same main pipe portion; water or oil dirt output through the main pipe portion is branched to the plurality of vertical portions; and the plurality of vertical portions are all connected to the discharging portion.

Optionally, a connecting pipe is arranged between the plurality of vertical portions, and the connecting pipe is located on a lower side of the main pipe portion and close to the main pipe portion; and
two ends of the connecting pipe are respectively in communication with the plurality of vertical portions.

Optionally, the vertical portion is internally provided with a filter member, and the filter member is connected to the vertical portion and is configured to filter out impurities input through the vertical portion; and
the filter member extends in a length direction of the vertical portion and filters step by step from top to bottom.

Optionally, a plurality of filter members are provided, the plurality of filter members are stacked in a vertical direction to form a plurality of filter layers, and the filter layers have inconsistent filtering capacities.

Optionally, the filtering capacity of a filter member of an upper layer is lower than that of a filter member of a lower layer.

Optionally, the filter member is a filter screen; and
a part of the vertical portion opposite the filter screen is a transparent portion, and the transparent portion is used for viewing by a user.

Optionally, the siphon fish tank cleaning device further comprises a siphon destruction pipe, wherein the siphon destruction pipe is connected to the water pipe, and the siphon destruction pipe is in communication with the main pipe portion; and
the siphon destruction pipe is bendably arranged, one end of the siphon destruction pipe is located inside the fish tank, and the other end thereof is located outside the fish tank.

Optionally, one end of the siphon destruction pipe is used as a siphon destruction portion, and a height position of the siphon destruction portion is lower than that of the feeding portion; and
when the siphon destruction portion exceeds the water surface, air enters the siphon destruction pipe to destroy a siphon effect of the water pipe.

Optionally, the siphon destruction portion is provided with a plurality of second water ports, and the plurality of second water ports are annularly provided along the siphon destruction portion and are configured to allow water or air to enter; and the second water ports are arc-shaped.

Optionally, a second switch is connected to the siphon destruction pipe, and the second switch is close to the other end of the siphon destruction pipe to open or close an outlet of the siphon destruction pipe.

Optionally, the siphon destruction pipe is liftably connected to the water pipe to adjust the height position of the siphon destruction portion, thereby adjusting a height difference between the height position of the siphon destruction portion and the height position of the feeding portion.

Optionally, the siphon fish tank cleaning device further comprises a lower water inlet pipe, the lower water inlet pipe is in communication with the water pipe and is located on a lower side of the bent portion; and a water inlet of the lower water inlet pipe is close to a bottom of the fish tank and is configured to suck impurities at the bottom of the fish tank.

Optionally, the lower water inlet pipe and the feeding portion are in communication with the bent portion, and the lower water inlet pipe is located on a lower side of the feeding portion.

Compared with the prior art, the present invention has the following beneficial effects.

The present invention provides a siphon fish tank cleaning device. A support assembly comprises a support and a sucker, and the support is located in a fish tank. A fixed end of the sucker is connected to the support, and a suction end of the sucker sucks a side wall of the fish tank in a horizontal direction. A pipeline assembly is mounted on the support. The pipeline assembly comprises a water pipe, a feeding portion, and a discharging portion. The water pipe is provided in a snake shape, and is partially located in the fish tank. The feeding portion is connected to a water inlet of the water pipe and floats on a water surface, and the feeding portion sucks oil dirt collected via the water surface and conveys the oil dirt to the water pipe. The discharging portion is connected to a water outlet of the water pipe and is located outside the fish tank. The discharging portion receives the oil dirt conveyed through the water pipe and discharges the oil dirt outside the fish tank. The discharging portion and the feeding portion are located inside and outside the fish tank respectively. In this case, a height position of the discharging portion is lower than that of the feeding portion, and a siphon structure is formed based on the feeding portion, the water pipe, and the discharging portion, so that the oil dirt is sucked by a siphon force, to facilitate autonomous discharge of the oil dirt under the siphon action without water pump type drainage, which avoids relying on electricity and improves safety of the siphon fish tank cleaning device. In addition, the fixed end of the sucker is connected to the support, and the suction end of the sucker sucks an inner side wall of the fish tank in a horizontal direction, thereby implementing convenient fixation.

### BRIEF DESCRIPTION OF THE DRAWINGS

For a clearer description of the technical solutions in the embodiments of the present application, the accompanying drawings required for describing the embodiments are briefly described below. Apparently, the accompanying drawings in the following description show merely some embodiments of the present application, and those skilled in the art may still derive other accompanying drawings from these accompanying drawings without creative efforts.

In order to understand the present application and beneficial effects thereof more completely, the following description is made with reference to the accompanying drawings. In the following description, the same reference signs denote the same parts.

FIG. 1 shows a schematic diagram of a siphon fish tank cleaning device according to an embodiment of the present application.

FIG. 2 shows a schematic diagram of a support assembly of a siphon fish tank cleaning device according to an embodiment of the present application.

FIG. 3 shows a schematic diagram of a feeding portion of a siphon fish tank cleaning device according to an embodiment of the present application.

FIG. 4 shows a schematic diagram illustrating connection between a water pipe and a discharging portion of a siphon fish tank cleaning device according to an embodiment of the present application.

FIG. 5 shows a schematic diagram of a siphon destruction pipe of a siphon fish tank cleaning device according to an embodiment of the present application.

### DETAILED DESCRIPTION OF EMBODIMENTS

The technical solutions in the embodiments of the present application are clearly and completely described below with reference to the accompanying drawings in the embodiments of the present application. Apparently, the described embodiments are only some embodiments rather than all the embodiments of the present application. All other embodiments obtained by those skilled in the art based on the embodiments of the present application without creative efforts fall within the protection scope of the present application.

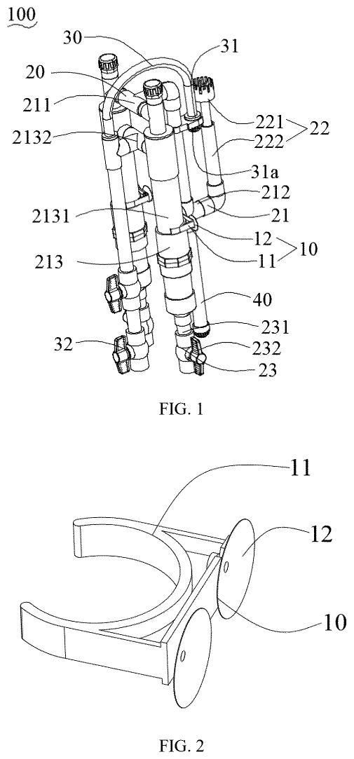

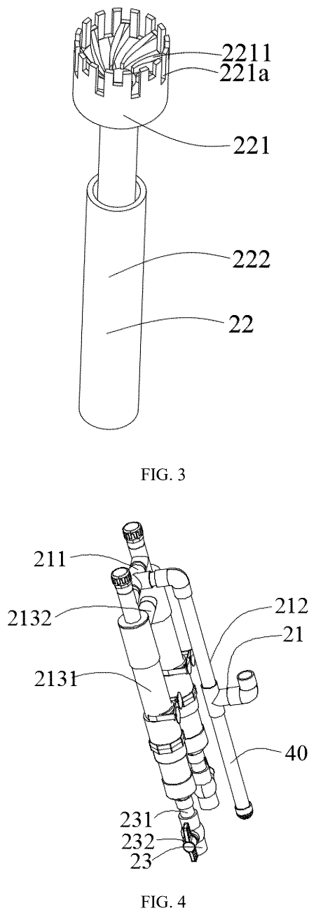

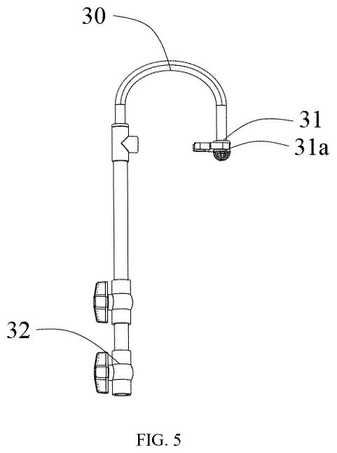

As shown in FIGS. 1-5, an embodiment of the present application provides a siphon fish tank cleaning device 100, and the siphon fish tank cleaning device 100 is applied to a fish tank dirt discharge scenario. The siphon fish tank cleaning device 100 is used to clean a fish tank. The siphon fish tank cleaning device 100 comprises a support assembly 10 and a pipeline assembly 20, and the pipeline assembly 20 is arranged outside the support assembly 10.

In the embodiment of the present application, the support assembly 10 serves as a supporting component of the siphon fish tank cleaning device 100, and the support assembly 10 supports the pipeline assembly 20. The support assembly 10 comprises a support 11 and a sucker 12, and the support 11 is located in the fish tank. A fixed end of the sucker 12 is connected to the support 11, and a suction end of the sucker 12 sucks a side wall of the fish tank in a horizontal direction, to facilitate fixation of the support 11 to the side wall of the fish tank by the sucker 12, thereby facilitating fixation of the siphon fish tank cleaning device 100 to the side wall of the fish tank, and implementing convenient fixation.

In the embodiment of the present application, the pipeline assembly 20 is mounted on the support 11; and the pipeline assembly 20 comprises a water pipe 21, a feeding portion 22, and a discharging portion 23. The water pipe 21 is provided in a snake shape, and is partially located in the fish tank. The feeding portion 22 is connected to a water inlet of the water pipe 21 and floats on a water surface, and the feeding portion 22 sucks oil dirt collected via the water surface and conveys the oil dirt to the water pipe 21. The discharging portion 23 is connected to a water outlet of the water pipe 21 and is located outside the fish tank. The discharging portion 23 receives the oil dirt conveyed through the water pipe 21 and discharges the oil dirt outside the fish tank. The discharging portion 23 and the feeding portion 22 are located inside and outside the fish tank respectively.

In this case, a height position of the discharging portion 23 is lower than that of the feeding portion 22, and a siphon structure is formed based on the feeding portion 22, the water pipe 21, and the discharging portion 23, so that the oil dirt is sucked by a siphon force, to facilitate autonomous discharge of the oil dirt under the siphon action without water pump type drainage, which avoids relying on electricity and improves safety of the siphon fish tank cleaning device 100.

In the embodiment of the present application, the feeding portion 22 comprises a first body 221 and a first connecting end 222; and the first connecting end 222 is located on a lower side of the first body 221. The first connecting end 222 is provided in a vertical direction, and is inserted into the water outlet of the water pipe 21. An outer side wall of the first connecting end 222 is hermetically connected to an inner side wall of the water inlet of the water pipe 21, or a gap for water to pass through is provided between the outer side wall of the first connecting end 222 and the inner side wall of the water inlet of the water pipe 21, thereby avoiding water leakage at a joint between the first connecting end 222 and the water pipe 21.

In this case, the first body 221 is made of a floatable material and floats on the water surface. The first body 221 is in communication with the first connecting end 222 and is in communication with the water inlet of the water pipe 21 by the first connecting end 222, so that the first body 221 can suck the oil dirt collected via the water surface, thus facilitating the flowing of the oil dirt to the water inlet of the water pipe 21 through the first body 221 and the first connecting end 222. The first body 221 is provided with a plurality of first water ports 221a, the plurality of first water ports 221a are uniformly provided along an outer side wall of the first body 221 and converge at a central hole of the first body 221, and the plurality of first water ports 221a allow the oil dirt to enter in different directions respectively, so as to facilitate the flowing of the oil dirt to the central hole of the first body 221 through the plurality of first water ports 221a. With the arrangement of the plurality of first water ports 221a, efficiency of entry of the oil dirt into the central hole of the first body 221 is increased.

Specifically, the plurality of first water ports 221a are all staged grooves; and each first water port 221a is located at the water surface, and a bottom of the first water port 221a is lower than the water surface. The first body 221 is further provided with spiral flow channels 2211, the spiral flow channels 2211 are located between the first water ports 221a and the central hole, and the first water ports 221a, the spiral flow channels 2211 and the central hole are in communication with each other and are configured to convey water and oil dirt, to facilitate flowing of the oil dirt to the spiral flow channels 2211 through the first water ports 221a, so as to facilitate flowing of the oil dirt to flow to the central hole under guidance of the spiral flow channels 2211. With the design of the spiral flow channels 2211, an effect of accelerating the flowing of the oil dirt is achieved by tightening a flow surface, thereby facilitating an increase in a flow velocity of the oil dirt relative to the central hole.

In addition, a plurality of spiral flow channels 2211 are provided, and a number of the spiral flow channels 2211 is consistent with that of the first water ports 221a. The plurality of spiral flow channels 2211 are provided at intervals in an annular direction of the first body 221 and converge at the same central hole. Each spiral flow channel 2211 extends spirally from top to bottom, so that each spiral flow channel 2211 corresponds to a first water port 221a. With the arrangement of the plurality of spiral flow channels 2211, the flow velocity of the oil dirt relative to the central hole is increased.

An aperture of a water inlet end of the spiral flow channel 2211 is greater than that of a water outlet end of the spiral flow channel 2211. The aperture of the spiral flow channel 2211 gradually decreases in a spiral direction of the spiral flow channel 2211, to increase the flow velocity of the oil dirt, and thus facilitate the converging of the oil dirt to the central hole through the plurality of first water ports 221a and spiral flow channels 2211.

In this case, the feeding portion 22 is rotatably connected to the water pipe 21 and rotates along an axis of the feeding portion 22, to facilitate the adjustment of the position of the feeding portion 22 relative to the water pipe 21. When water enters the first water port 221a, the water impacts the spiral flow channel 2211 and applies rotating power to the feeding portion 22, the feeding portion 22 rotates relative to the water pipe 21 under the action of the rotating power, and at the same time, a water inlet situation of the water pipe 21 is reflected based on a rotating situation of the feeding portion 22, so that the feeding portion 22 drives the water to spiral, thereby facilitating the increase of the flow velocity of the water.

In the embodiment of the present application, the water pipe 21 comprises a main pipe portion 211, a bent portion 212, and a vertical portion 213. An upper end of the bent portion 212 is used as the water inlet, and the bent portion 212 is located in the fish tank and is immersed in the water. The main pipe portion 211 is provided in a horizontal direction and is in communication with the bent portion 212 and the vertical portion 213, so that the oil dirt in the first connecting end 222 passes through the bent portion 212, the main pipe portion 211 and the vertical portion 213 in sequence. The vertical portion 213 is located on a side of the bent portion 212, an accommodating groove is formed between the vertical portion and the bent portion 212, and the accommodating groove is configured to a side plate of the fish tank to pass through, so that the water pipe 21 avoids the side plate of the fish tank through the accommodating groove, and thus the bent portion 212 and the vertical portion 213 are located inside and outside the fish tank respectively.

In this case, the vertical portion 213 extends in a vertical direction, and the discharging portion 23 is connected to the vertical pipe 231, to facilitate the flowing of the oil dirt in the vertical portion 213 to the discharging portion 23, so that the discharging portion 23 is located outside the fish tank. A first switch 232 is connected to the discharging portion 23, and the first switch 232 is configured to open or close the water outlet of the water pipe 21, so that the first switch 232 can control an oil dirt flow situation in the discharging portion 23. When the first switch 232 opens the water outlet of the water pipe 21, the discharge of the oil dirt in the discharging portion 23 to an external environment is facilitated, and when the first switch 232 closes the water outlet of the water pipe 21, the oil dirt in the discharging portion 23 is kept still.

A plurality of vertical portions 213 are provided, and the plurality of vertical portions 213 are arranged in a horizontal direction and are in communication with the same main pipe portion 211. Water or oil dirt output through the main pipe portion 211 is branched to the plurality of vertical portions 213. The plurality of vertical portions 213 are connected to the discharging portion 23, and the efficiency of discharge of the water or oil dirt relative to the discharging portion 23 is increased by arranging the plurality of vertical portions 213.

In this case, a connecting pipe 2132 is provided between the plurality of vertical portions 213, and the connecting pipe 2132 is located on a lower side of the main pipe portion 211 and close to the main pipe portion 211. Two ends of the connecting pipe 2132 are respectively in communication with the plurality of vertical portions 213, and the plurality of vertical portions 213 improve connection stability between the plurality of vertical pipes 231 by the connecting pipe 2132, thereby facilitating mutual flow of the water or oil dirt in the plurality of vertical portion 213.

In the embodiment of the present application, the vertical portion 213 is internally provided with a filter member, and the filter member is connected to the vertical portion 213 and is configured to filter out impurities input through the vertical portion 213. The filter member extends in a length direction of the vertical portion 213 and filters step by step from top to bottom, so that the water or the oil dirt is filtered out by the filter member and then is discharged to the external environment.

In this case, a plurality of filter members are provided, the plurality of filter members are stacked in a vertical direction to form a plurality of filter layers, and the filter layers have inconsistent filtering capacities. A filtering effect of the filter members relative to the water or the oil dirt is improved by arranging the plurality of filter members. The filtering capacity of a filter member of an upper layer is lower than that of a filter member of a lower layer, which ensures a stable filtering effect of the filter members. Optionally, the filter member is a filter screen.

A part of the vertical portion 213 opposite the filter screen is a transparent portion 2131, and the transparent portion 2131 is used for viewing by a user, so that the user knows the usage situation of the filter screen, thereby facilitating timely replacement of the filter screen by the user and preventing a case in which the vertical portion 213 is disassembled to view a situation of the filter screen.

The siphon fish tank cleaning device 100 further comprises a siphon destruction pipe 30, and the siphon destruction pipe 30 is connected to the water pipe 21, to facilitate fixation of the siphon destruction pipe 30 to the water pipe 21. The siphon destruction pipe 30 is in communication with the main pipe portion 211, to facilitate flowing of the water or the air to the main pipe portion 211 through the siphon destruction pipe 30. The siphon destruction pipe 30 is bendably arranged, one end of the siphon destruction pipe 30 is located inside the fish tank, and the other end thereof is located outside the fish tank, so that the two ends of the siphon destruction pipe 30 are located inside and outside the fish tank respectively.

One end of the siphon destruction pipe 30 is used as a siphon destruction portion 31, and a height position of the siphon destruction portion 31 is lower than that of the feeding portion 22. When the siphon destruction portion 31 exceeds the water surface, the air enters the siphon destruction pipe to destroy a siphon effect of the water pipe 21, and the water is prevented from entering the siphon destruction pipe 30, thereby facilitating flowing of the air to the main pipe portion 211 through the siphon destruction pipe 30.

The siphon destruction portion 31 is provided with a plurality of second water ports 31a, and the plurality of second water ports 31a are annularly provided along the siphon destruction portion 31 and are configured to allow water or air to enter. The second water ports 31a are arc-shaped, to facilitate flowing of the water or the air to the siphon destruction pipe 30 through the plurality of second water ports 31a. The flow velocity of the water or the air relative to the siphon destruction pipe 30 is increased by arranging the plurality of second water ports 31a.

A second switch 32 is connected to the siphon destruction pipe 30, and the second switch 32 is close to the other end of the siphon destruction pipe 30 to open or close an outlet of the siphon destruction pipe 30, so that the second switch 32 can control the siphon destruction pipe 30 to discharge water or air. When the second switch 32 opens the outlet of the siphon destruction pipe 30, the external environment can be in communication with the outlet of the siphon destruction pipe, thus facilitating the flowing of the water or the air in the siphon destruction pipe 30 to the external environment. When the second switch 32 closes the outlet of the siphon destruction pipe 30, the water or the air in the siphon destruction pipe 30 is prevented from flowing to the external environment.

The siphon destruction pipe 30 is liftably connected to the water pipe 21 to adjust the height position of the siphon destruction portion 31, thereby adjusting a height difference between the height position of the siphon destruction portion 31 and the height position of the feeding portion 22.

The siphon fish tank cleaning device 100 further comprises a lower water inlet pipe 40, and the lower water inlet pipe 40 is in communication with the water pipe 21 and is located on a lower side of the bent portion 212. A water inlet of the lower water inlet pipe 40 is close to a bottom of the fish tank and is configured to suck impurities at the bottom of the fish tank, to facilitate the flowing of the impurities at the bottom of the fish tank to the water pipe 21 through the lower water inlet pipe 40.

The lower water inlet pipe 40 and the feeding portion 22 are in communication with the bent portion 212, and the lower water inlet pipe 40 is located on a lower side of the feeding portion 22, so that the bottom impurities can flow to the bent portion 212 from the bottom up through the lower water inlet pipe 40, and top impurities can flow to the bent portion 212 from the top down through the feeding portion 22, thereby ensuring that the impurities in the fish tank are cleaned out in place.

In the foregoing embodiments, the descriptions of various embodiments have respective focuses. For a part that is not described in detail in an embodiment, reference may be made to related descriptions in other embodiments.

In the description of the present application, the terms “first” and “second” are used for descriptive purposes only, and cannot be construed as indicating or implying relative importance or implicitly indicating the number of technical features indicated. Thus, the features defined with “first” and “second” may explicitly or implicitly include one or more of the features.

The principle and implementation of the present application are illustrated by applying specific examples herein. The description of the above embodiments is only used to help understand the method and its core idea of the present application. In addition, for those skilled in the art, changes may be made to the specific implementations and application range based on the idea of the present application. In conclusion, the contents of this specification should not be construed as a limitation to the present application.

What is claimed is:

1. A siphon fish tank cleaning device, characterized in that, the device is applied to a fish tank dirt discharge scenario, and the siphon fish tank cleaning device comprises:
a support assembly comprising a support and a sucker, wherein the support is located in a fish tank; and a fixed end of the sucker is connected to the support, and a suction end of the sucker sucks a side wall of the fish tank in a horizontal direction; and
a pipeline assembly mounted on the support, wherein the pipeline assembly comprises a water pipe, a feeding portion, and a discharging portion, wherein
the water pipe is provided in a snake shape, and is partially located in the fish tank;
the feeding portion is connected to a water inlet of the water pipe and floats on a water surface, and the feeding portion sucks oil dirt collected via the water surface and conveys the oil dirt to the water pipe; and
the discharging portion is connected to a water outlet of the water pipe and is located outside the fish tank, the discharging portion receives the oil dirt conveyed through the water pipe and discharges the oil dirt outside the fish tank, and the discharging portion and the feeding portion are located inside and outside the fish tank respectively, at the same time, a height position of the discharging portion is lower than that of the feeding portion, and in this case, a siphon structure is formed based on the feeding portion, the water pipe, and the discharging portion, so that the oil dirt is sucked by a siphon force.

2. The siphon fish tank cleaning device according to claim 1, characterized in that, the feeding portion comprises a first body and a first connecting end;
the first connecting end is located on a lower side of the first body and is inserted into the water outlet of the water pipe; and an outer side wall of the first connecting end is hermetically connected to an inner side wall of the water inlet of the water pipe, or a gap for water to pass through is provided between the outer side wall of the first connecting end and the inner side wall of the water inlet of the water pipe;
the first body is made of a floatable material and floats on the water surface; and the first body is in communication with the first connecting end and is in communication with the water inlet of the water pipe by the first connecting end; and
the first body is provided with a plurality of first water ports, the plurality of first water ports are uniformly provided along an outer side wall of the first body and converge at a central hole of the first body, and the plurality of first water ports allow the oil dirt to enter in different directions respectively.

3. The siphon fish tank cleaning device according to claim 2, characterized in that, the plurality of first water ports are all staged grooves; each first water port is located at the water surface, and a bottom of the first water port is lower than the water surface; and
the first body is further provided with spiral flow channels, the spiral flow channels are located between the first water ports and the central hole, and the first water ports, the spiral flow channels and the central hole are in communication with each other and are configured to convey water and oil dirt.

4. The siphon fish tank cleaning device according to claim 3, characterized in that, a plurality of spiral flow channels are provided, and a number of the spiral flow channels is consistent with that of the first water ports; and
the plurality of spiral flow channels are provided at intervals in an annular direction of the first body and converge at the same central hole; and each spiral flow channel spirally extends from top to bottom.

5. The siphon fish tank cleaning device according to claim 4, characterized in that, an aperture of a water inlet end of the spiral flow channel is greater than that of a water outlet end of the spiral flow channel; and
the aperture of the spiral flow channel gradually decreases in a spiral direction of the spiral flow channel.

6. The siphon fish tank cleaning device according to claim 3, characterized in that, the feeding portion is rotatably connected to the water pipe and rotates along an axis of the feeding portion; and
when water enters the first water port, the water impacts the spiral flow channel and applies rotating power to the feeding portion, the feeding portion rotates relative to the water pipe under the action of the rotating power, and at the same time, a water inlet situation of the water pipe is reflected based on a rotating situation of the feeding portion.

7. The siphon fish tank cleaning device according to claim 1, characterized in that, the water pipe comprises a main pipe portion, a bent portion, and a vertical portion;
an upper end of the bent portion is used as the water inlet, and the bent portion is located in the fish tank and is immersed in water;
the main pipe portion is arranged in a horizontal direction and is in communication with the bent portion and the vertical portion; the vertical portion is located on a side of the bent portion, an accommodating groove is formed between the vertical portion and the bent portion, and the accommodating groove is configured to a side plate of the fish tank to pass through; and
the vertical portion extends in a vertical direction, the discharging portion is connected to the vertical pipe, a first switch is connected to the discharging portion, and the first switch is configured to open or close the water outlet of the water pipe.

8. The siphon fish tank cleaning device according to claim 7, characterized in that, a plurality of vertical portions are provided, and the plurality of vertical portions are arranged in a horizontal direction and are in communication with the same main pipe portion; water or oil dirt output through the main pipe portion is branched to the plurality of vertical portions; and the plurality of vertical portions are all connected to the discharging portion.

9. The siphon fish tank cleaning device according to claim 8, characterized in that, a connecting pipe is arranged between the plurality of vertical portions, and the connecting pipe is located on a lower side of the main pipe portion and close to the main pipe portion; and
two ends of the connecting pipe are respectively in communication with the plurality of vertical portions.

10. The siphon fish tank cleaning device according to claim 7, characterized in that, the vertical portion is internally provided with a filter member, and the filter member is connected to the vertical portion and is configured to filter out impurities input through the vertical portion; and
the filter member extends in a length direction of the vertical portion and filters step by step from top to bottom.

11. The siphon fish tank cleaning device according to claim 10, characterized in that, a plurality of filter members are provided, the plurality of filter members are stacked in a vertical direction to form a plurality of filter layers, and the filter layers have inconsistent filtering capacities.

12. The siphon fish tank cleaning device according to claim 11, characterized in that, the filtering capacity of a filter member of an upper layer is lower than that of a filter member of a lower layer.

13. The siphon fish tank cleaning device according to claim 10, characterized in that, the filter member is a filter screen; and
a part of the vertical portion opposite the filter screen is a transparent portion, and the transparent portion is used for viewing by a user.

14. The siphon fish tank cleaning device according to claim 7, further comprising a siphon destruction pipe, characterized in that, the siphon destruction pipe is connected to the water pipe, and the siphon destruction pipe is in communication with the main pipe portion; and
the siphon destruction pipe is bendably arranged, one end of the siphon destruction pipe is located inside the fish tank, and the other end thereof is located outside the fish tank.

15. The siphon fish tank cleaning device according to claim 14, characterized in that, one end of the siphon destruction pipe is used as a siphon destruction portion, and a height position of the siphon destruction portion is lower than that of the feeding portion; and
when the siphon destruction portion exceeds the water surface, air enters the siphon destruction pipe to destroy a siphon effect of the water pipe.

16. The siphon fish tank cleaning device according to claim 15, characterized in that, the siphon destruction portion is provided with a plurality of second water ports, and the plurality of second water ports are annularly provided along the siphon destruction portion and are configured to allow water or air to enter; and the second water ports are arc-shaped.

17. The siphon fish tank cleaning device according to claim 15, characterized in that, a second switch is connected to the siphon destruction pipe, and the second switch is close to the other end of the siphon destruction pipe to open or close an outlet of the siphon destruction pipe.

18. The siphon fish tank cleaning device according to claim 15, characterized in that, the siphon destruction pipe is liftably connected to the water pipe to adjust the height position of the siphon destruction portion, thereby adjusting a height difference between the height position of the siphon destruction portion and the height position of the feeding portion.

19. The siphon fish tank cleaning device according to claim 7, further comprising a lower water inlet pipe, characterized in that, the lower water inlet pipe is in communication with the water pipe and is located on a lower side of the bent portion; and a water inlet of the lower water inlet pipe is close to a bottom of the fish tank and is configured to suck impurities at the bottom of the fish tank.

20. The siphon fish tank cleaning device according to claim 19, characterized in that, the lower water inlet pipe and the feeding portion are in communication with the bent portion, and the lower water inlet pipe is located on a lower side of the feeding portion.
